(19) United States
(12) Patent Application Publication
(10) Pub. No.: US 2025/0192910 A1
(43) Pub. Date: Jun. 12, 2025

(54) Optical Network Nodes

(71) Applicant: Telefonaktiebolaget LM Ericsson (publ), Stockholm (SE)

(72) Inventors: Luca Giorgi, Pisa (IT); Fabio Cavaliere, Pisa (IT)

(21) Appl. No.: 18/847,411

(22) PCT Filed: Mar. 17, 2022
(86) PCT No.: PCT/EP2022/056984

§ 371 Date: Sep. 16, 2024

(51) Int. Cl. H04J 14/02

(52) U.S. Cl. CPC H04J 14/021; H04J 14/0283

(57) ABSTRACT

The present application relates to a first optical network node (400, 700, 800) that comprises: a first optical add-drop multiplexer, OADM (410) coupled to a first optical fibre (401); a transceiver (420) comprising a receiver (422) and a transmitter (424); and an optical configuration unit (430) 5 coupled between the transceiver (420) and the first OADM (410), wherein the optical configuration unit (430) is operable to selectively couple the receiver (422) to the first OADM (410) so as to receive a first optical signal dropped from the first optical fibre (401) or to selectively couple the transmitter (424) to the first OADM (410) so as to add a second optical signal to the first optical fibre (401).

### TECHNICAL FIELD

The present application relates to a first optical network node. The present application also relates to an optical network and a method performed in a first optical network node.

### BACKGROUND

Optical networks based on Wavelength Division Multiplexing (WDM) are a key building block in many telecommunications systems. These networks are realized using a number of wavelength management devices, including multiplexers (MUX) demultiplexers (DEMUX) and optical add-drop multiplexers (OADMs).

A MUX is a device with N input optical fibres and one output optical fibre. N input wavelengths may thus be received at the MUX on the N input fibres and the MUX is able to route the N input wavelengths into a unique wavelength comb for transmission along the output fibre. A DEMUX is a device with one input optical fibre and N output optical fibres. The DEMUX is able to extract each individual wavelength of an input wavelength comb received on the input optical fibre and route each wavelength of the comb on to one of the assigned N output fibres.

An OADM is a two section wavelength-selective device, including an add section where a wavelength can be added to a received wavelength comb travelling along an optical fibre and a drop section where a wavelength can be dropped from the wavelength comb travelling along the optical fibre. Each section has one input line port, one output line port and M channel ports. The channel ports in the drop section are referred to as drop ports and the channel ports in the add section are referred to as add ports.

In the drop section, one or more wavelengths of an incoming wavelength comb are routed from the input line port to a corresponding local drop port. The remaining wavelengths in the comb pass through the drop section. In the add section, one or more wavelengths are added to the wavelength comb that passes through the drop section, so forming a new comb. The added wavelengths correspond to those dropped in the drop section. The wavelengths are added using add ports, coupled to a transmitter.

OADMs can thus add and drop wavelengths transmitted along an optical fibre in a wavelength comb. A Reconfigurable OADM (ROADM) provides the ability to arbitrarily select and switch the wavelengths dropped from and added to the wavelength comb.

FIGS. 1a-c illustrate example architectures of optical networks. FIG. 1a illustrates a ring network architecture 100a, FIG. 1b illustrates a bus network architecture 100b and FIG. 1c illustrates a tree network architecture 100c.

Optical networks using WDM technology, such as those illustrated in FIGS. 1a-c, are based on a hierarchical structure including a main node, called a hub node 110, and one or more add/drop nodes 120a-d connected with optical fibres. The hub node generates the transmitted wavelength comb (usually named a downstream comb) and terminates wavelengths received from the add/drop nodes (that form an upstream comb). Therefore, no wavelengths pass through the hub node, all wavelengths are either transmitted from the hub node or terminated at the hub node. A number of optical paths are thus formed between the hub node and each one of the add/drop nodes 110a-d. A specific wavelength is used for each optical path formed between a hub node and a add/drop node. In other words, a hub node cannot communicate with one add/drop node on a first wavelength and also communicate with a second add/drop node using the first wavelength.

Due to the hierarchical structure of conventional WDM networks, each add/drop node of the network communicates with the hub node. However, a communication channel cannot exist between two add/drop nodes of conventional WDM networks. For one of the add/drop nodes to communicate with another of the add/drop nodes, this communication can only be facilitated through communication via the hub node.

Alternative WDM network architectures, not based on OADMs, exist. In these architectures the wavelength selective devices at each of the nodes are replaced by power splitters and combiners and the wavelength selection function is performed at the transceiver. At the transmitter of the transceiver, the wavelength is selected by means of a tunable laser. At the receiver of the transceiver, a tunable optical filter is used in direct detection optical interfaces, while in coherent optical interfaces the wavelength is selected by the local oscillator. Examples of these kinds of architectures, are referred to as Broadcast-and-Select (B&S) architectures.

B&S network architectures, include a Wavelength-select WDM passive optical network (WS-PON), which are of interest in mobile transport for fronthaul applications over installed passive optical network (PON) infrastructures. This kind of architecture is also called PON with WDM overlay. One reason for their interest, is because it is possible to form these network architectures using a non-hierarchical structure, where each node in the network can communicate with each other node and not exclusively with a hub node.

In B&S architectures, chains of optical add-drop nodes, each one consisting of a passive splitter taps a WDM optical signal along an optical fibre and broadcasts the WDM optical signal to a number of optical ports, each port connected to a transceiver. The portion of the signal that is not tapped continues to propagate to the next add/drop node. The paper entitled “A broadcast-and-select OADM optical network with dedicated optical-channel protection” by J.-K. Rhee; I. Tomkos; Ming-Jun Li, Journal of Lightwave Technology (Vol. 21, no. 1, pp. 25-31, January 2003), discloses such a B&S architecture, where a two-fibre optical-ring network with nodes based on a B&S-OADM architecture is disclosed. The nodes in this paper use wavelength-selective switches at each node. This architecture is used in fronthaul applications to connect a baseband processing node to distant remote units placed at different locations. However, this architecture also uses power splitters at each node, which greatly increases optical path losses.

### SUMMARY

Examples according to the present disclosure therefore aim to provide an optical network node, an optical network and a method that at least partially address one or more of the challenges discussed above.

According to a first aspect there is provided a first optical network node that comprises: a first optical add-drop multiplexer (OADM) coupled to a first optical fibre; a transceiver comprising a receiver and a transmitter; and an optical configuration unit coupled between the transceiver and the first OADM, wherein the optical configuration unit is operable to selectively couple the receiver to the first OADM so as to receive a first optical signal dropped from the first optical fibre or to selectively couple the transmitter to the first OADM so as to add a second optical signal to the first optical fibre.

According to a second aspect there is provided an optical network that comprises: a plurality of optical network nodes; and a first optical fibre coupled to each of the plurality of optical network nodes; wherein each of the plurality of optical network nodes comprises: a first optical add-drop multiplexer, OADM coupled to the first optical fibre; a transceiver comprising a receiver and a transmitter; and an optical configuration unit coupled between the transceiver and the first OADM, wherein the optical configuration unit is operable to selectively couple the receiver to the first OADM so as to receive a first optical signal dropped from the first optical fibre or to selectively couple the transmitter to the first OADM so as to add a second optical signal to the first optical fibre.

According to a third aspect there is provided a method, performed in a first optical network node, the method comprising: selectively coupling, using an optical configuration unit, a receiver of a transceiver to a first OADM, coupled to a first optical fibre, so as to drop a first optical signal from the first optical fibre or selectively coupling, using the optical configuration unit, a transmitter of the transceiver to the first OADM so as to add a second optical signal to the first optical fibre.

### BRIEF DESCRIPTION OF THE DRAWINGS

For a better understanding of the present disclosure, and to show more clearly how it may be carried into effect, reference will now be made, by way of example, to the following drawings in which:

FIGS. 1a-c are examples of optical network architectures;

FIG. 2 is an example of an optical ring network;

FIG. 3 is another example of an optical ring network;

FIG. 4 is an example of an optical network node;

FIG. 5 is another example of an optical ring network;

FIG. 6 is an example of an optical bus network;

FIG. 7 is another example of an optical network node;

FIG. 8 is a further example of an optical network node;

FIG. 9 is an example of a method performed in an optical network node.

### DETAILED DESCRIPTION

The present disclosure relates to an optical network node that can be used to form a non-hierarchical WDM optical network, where each optical network node may communicate directly with any other optical network node in the network. Each optical network node comprises an OADM and an optical configuration unit that can selectively configure channel ports of the OADM to either add an optical signal to a WDM wavelength comb or drop an optical signal from the WDM wavelength comb, travelling along an optical fibre. As will be described in more detail below, the ability of the optical configuration unit to selectively add or drop an optical signal from the WDM wavelength comb on-the-fly, enables an optical network node to form a communication channel with any other network node of the network. For the purposes of the present disclosure, a wavelength, which is added or dropped from a WDM wavelength comb may be referred to as an “optical signal”.

To provide additional context to the description of optical network nodes according to the present disclosure, there now follows a discussion of WDM techniques used in optical networks.

Conventional optical networks using WDM technologies, based on non-reconfigurable wavelength selective devices, rigidly map wavelengths to particular network node channel ports, so as to establish the communication channels between the hub node and an add/drop node. This results in each node of the network including many devices such as transceivers and other optical devices, as each wavelength uses a respective set of devices in order to add and drop optical signals to and from an optical fibre. This leads to inflexibility and intensive network planning constraints, due to inventory issues and obtaining a large number of spare parts.

Reconfigurable devices, like ROADMs, overcome these issues. Today, ROADM are implemented with expensive wavelength selective switches. The cost associated with these devices is a potential barrier preventing the technology being implemented in mobile transport applications and, in particular, fronthaul networks. Integrated photonics has recently been used to form optical devices such as ROADMs, which has the potential to greatly reduce the cost associated with producing such devices. The paper entitled “Lossless ROADM by Exploiting low gain SOAs in fronthaul network” by P. N. Goki; M. Imran; F. Fresi; F. Cavaliere; L. Potì, 24th OptoElectronics and Communications Conference (OECC) and International Conference on Photonics in Switching and Computing (PSC), (July 2019) presents a mini-ROADM using an integrated reconfigurable silicon photonics switch based on microring resonators. The paper entitled “Integrated Reconfigurable Silicon Photonics Switch Matrix in IRIS Project: Technological Achievements and Experimental Results” by F. Testa et al., Journal of Lightwave Technology, (vol. 37, no. 2, pp. 345-355, January 2019) discloses that such a mini-ROADM based on integrated photonics can be used in a network node of a fronthaul network in a ring topology using a hierarchical structure.

WDM networks with a hierarchal structure prevent the direct instauration of an optical path between two add/drop nodes of the network. This is because an optical signal transmitted downstream by the hub node on a first optical fibre of the network is received by the add/drop node on the same first optical fibre. Vice versa, an optical signal transmitted upstream by the add drop node on a second optical fibre is received on the same second optical fibre by the hub node.

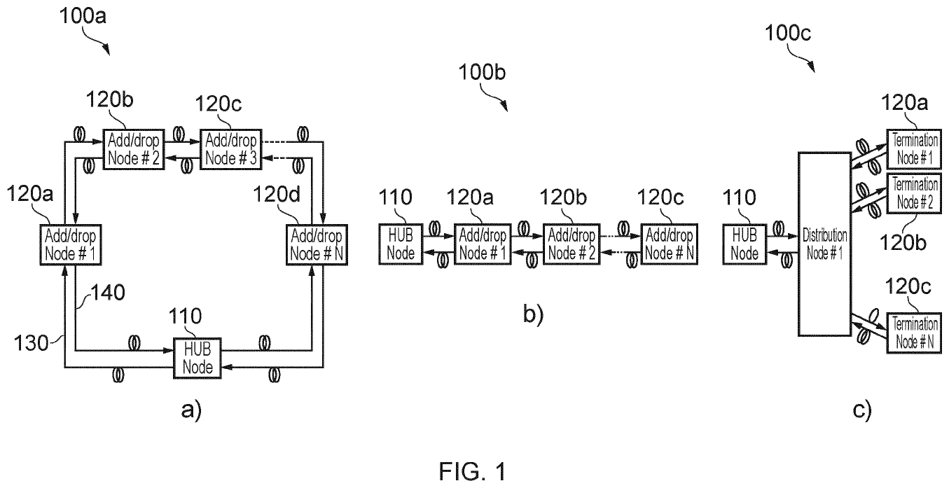

Referring again to FIG. 1a, in such examples, the node 110 may thus transmit a first optical signal to the second add/drop node 120b on the external optical fibre 130. The second add/drop node 120b may thus receive the first optical signal on the external optical fibre 130 and drop the first optical signal from the wavelength comb transmitted along the external optical fibre 130. The second add/drop node 120b may thus transmit a second optical signal to the hub node by adding the second optical signal to the internal optical fibre 140. The hub node may thus receive the second optical signal in a wavelength comb and terminate the second optical signal.

The first optical signal and the second optical signal may thus comprise the same wavelength, which is used by the network for forming the communication channel between the hub node 110 and the second add/drop node 120b. As the first and second optical signals are transmitted on different optical fibres 130, 140, travelling in different directions, this prevents reflection issues associated with the optical paths formed on the two fibres 130, 140 between the second add/drop node 120b and the hub node 110.

Forming an optical path between two add/drop nodes 120a-d of an optical network, such as optical network 100a, so that two add/drop nodes 120a-d may communicate directly and not exclusively with the hub node 110 may be possible, but many solutions suffer from a number of drawbacks.

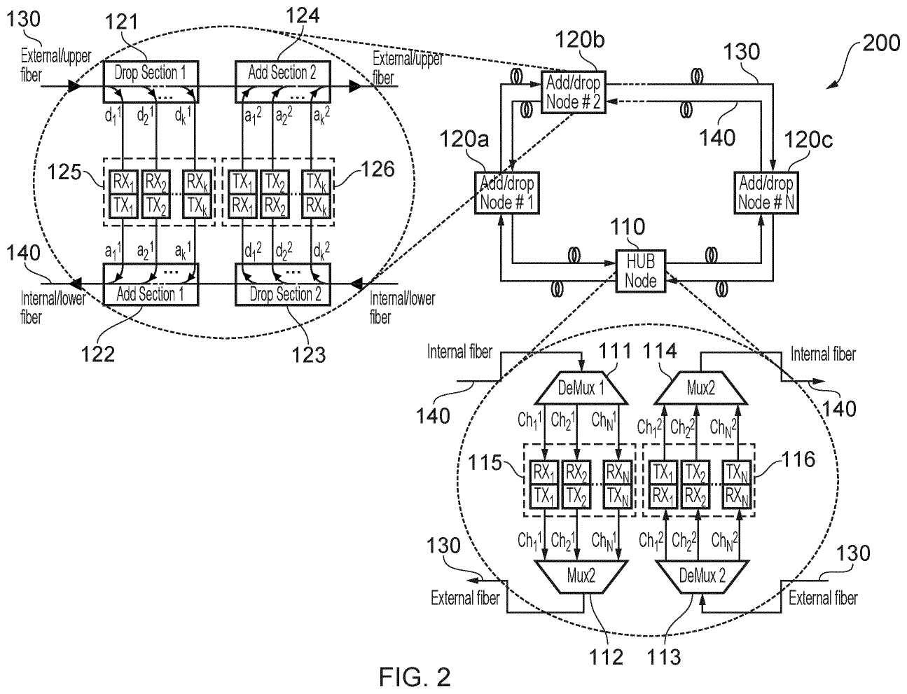

FIG. 2 illustrates one example of an optical ring network 200 where a communication channel may be formed between two add/drop nodes of the network 200 such that the two nodes can communicate directly. In examples according to the present disclosure direct communication between a first node and second node of the network may mean that an optical signal added to an optical fibre by a first add/drop node is dropped by a second add/drop node and that similarly, an optical signal added to another optical fibre by the second add/drop node is dropped by the first add/drop node. Optical network 200 comprises a number of elements in common with optical network 100a, which are labelled with corresponding reference numerals.

Optical network 200 comprises a hub node 110, which comprises a first DEMUX 111 for demultiplexing a wavelength comb received on the internal fibre 140. hub node 110 further comprises a first transceiver 115 for terminating wavelengths at the receivers Rx of first transceiver 115 received from the internal fibre 140. hub node 110 further comprises a first MUX 112 for multiplexing wavelengths transmitted from the transmitters Tx of the first transceiver 115. The first MUX 112 may thus multiplex the transmitted wavelengths into a wavelength comb for transmission along the external optical fibre 130.

[symbol] hub node 110 further comprises a second DEMUX 113 for demultiplexing a wavelength comb received on the external fibre 130. hub node 110 further comprises a second transceiver 116 comprising receivers Rx for terminating wavelengths received on the external fibre 130. hub node 110 further comprises a second MUX 114 for multiplexing wavelengths transmitted from the transmitters Tx of the second transceiver 116. The second MUX 114 may thus multiplex the transmitted wavelengths into a wavelength comb for transmission along the internal optical fibre 140.

Forming an optical communication channel between two add-drop nodes 120a-c of optical network 200, such that the two nodes can communicate directly with one another may require an additional OADM section at the add/drop nodes 120a-c. Second add/drop node 120b illustrates the architecture of a node including the additional OADM section.

Second add/drop node 120b includes a first drop section 121 for dropping wavelengths received on external fibre 130 to the receivers Rx of first transceiver 125. Second add/drop node 120b further comprises a first add section 122 for adding wavelengths to the internal optical fibre 140, transmitted by the transmitters Tx of the first transceiver 125. Second add/drop node 120b further comprises a second drop section 123 for dropping wavelengths received on internal fibre 140 to the receivers Rx of second transceiver 126. Second add/drop node 120b further comprises a second add section 124 for adding wavelengths to the external optical fibre 130, transmitted by the transmitters Tx of the second transceiver 126. The first drop section 121 and the second add section 124 may thus be included in the second add/drop node 120b to both add and drop a corresponding optical signal to and from the external optical fibre 130. Similarly, second add section 122 and the second drop section may be included to both add and drop a corresponding optical signal to and from the internal optical fibre 140. The inclusion of the first and second drop sections 121, 123 and the first and section add sections 122, 124 may enable the second add/drop node 120b to communicate with another add/drop node 120a, 120c of the network 200, as well as the hub node. Whilst the additional inclusion of the second drop section 123, the second add section 124 and the second transceiver 126 may enable such communication, their inclusion increases cost, would make the network more difficult to manage due to the greater number of components at each node, provides no mechanism to reroute an optical signal without manual intervention in field, and would further mean that ring protection is not enabled between two nodes of the network 200.

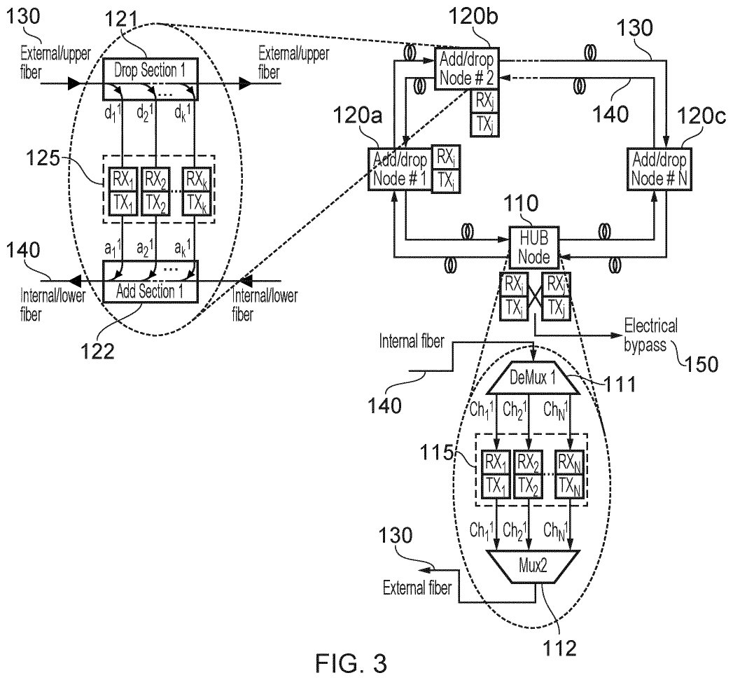

FIG. 3 illustrates another example of an optical network 300 where a communication channel may be formed between two add/drop nodes of the network 300 such that the two nodes can communicate directly. Optical network 300 comprises a number of elements in common with optical network 200, which are labelled with corresponding reference numerals. These elements may thus operate in a substantially corresponding way to that described above and are thus not described below for brevity.

As illustrated in FIG. 3, second add/drop node 120b comprises a first drop section 121, first add section 122 and first transceiver 125. The hub node 110 comprises first DEMUX 111, first MUX 112 and first transceiver 115. To enable communication between two add/drop nodes of the optical network 300, the first transceiver 115 of the hub node may be configured to perform an electrical bypass operation 150. In this operation, a first optical signal may be transmitted from one add/drop node to another add/drop node, which passes via the hub node 110. This first optical signal is received at a receiver Rx of the first transceiver 115 of the hub node. However, said first optical signal is immediately transmitted from a transmitter Tx of the transceiver 115 of the hub node 111. As such, the first optical signal can continue transmission around the network transmitted from the hub node 111 to the destination add/drop node.

For example, a communication channel may be established between first add/drop node 120a and second add/drop node 120b. A first optical signal may thus be transmitted from the second add/drop node 120b on the external fibre 130 towards the hub node 110. A receiver Rx of the first transceiver 115 may receive the first optical signal. First transceiver 115 may include a cross-connection between the receiver Rx and a transmitter Tx of the first transceiver 115 for transmitting an optical signal on to the external fibre 130 out of the hub node 110. Due to the cross-connection, an electrical bypass may thus be performed where the first optical signal received at a receiver Rx on the external optical fibre 130 is converted into the electrical domain, and immediately converted back to the optical domain by a transmitter Tx of the first transceiver 115 transmitting the first optical signal from the hub node 110 on the external fibre 130 towards the first add/drop node 120a. The first optical signal may thus be received at a receiver Rx of the first add/drop node 120a.

Similarly, a second optical signal may be transmitted from the first add/drop node 120a towards the second add/drop node 120b travelling via the hub node 110 on the internal optical fibre 140. A second optical signal may be transmitted by the first add/drop node 120a travelling towards the hub node 110 on the internal optical fibre 140. Due to a cross-connection at the first receiver 115 of the hub node 110, an electrical bypass operation may again be performed where the second optical signal is received at a receiver of the first transceiver 115, converted into the electrical domain and immediately reconverted into the optical domain, as the second optical signal is transmitted from a transmitter Tx of the first transceiver 115 on to the internal optical fibre 140. The second optical signal may thus travel along the internal optical fibre 140 until the signal is dropped to a receiver Rx of the first transceiver 125 of the second add/drop node 120b.

Thus, the optical network 300 may also enable two add/drop nodes of the network 300 to communicate directly by performing an electrical bypass operation at the transceiver 115 of the hub node 110. This operation means that for at least for some of the optical signals, the transceiver 115 acts as a regenerator. The architecture of optical network 300, however, suffers from two major drawbacks. Firstly, converting the optical signal to the electrical domain and back to the optical domain greatly reduces bandwidth and further increases cost, since a dedicated transceiver is used at the hub node for the conversion. Secondly, the latency of the architecture is poor due to the long optical path that may need to be implemented as transmission should pass via the hub node 110.

Examples according to the present disclosure thus relate to an optical network node which can communicate with any other optical network node in a network with reduced number of components, improved bandwidth and improved latency.

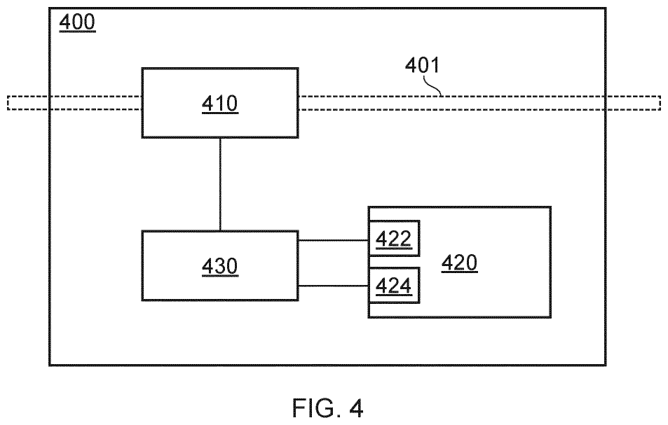

FIG. 4 illustrates an example of a first optical network node 400 according to the present disclosure. The first optical network node comprises a first OADM 410 coupled to a first optical fibre 401. The first optical network node 400 further comprises a transceiver 420 comprising a receiver 422 and a transmitter 424. The first optical network node 400 further comprises an optical configuration unit 430 coupled between the transceiver 420 and the first OADM 410. The optical configuration unit 430 is operable to selectively couple the receiver 422 to the first OADM 410 so as to receive a first optical signal dropped from the first optical fibre 401 or to selectively couple the transmitter 424 to the first OADM 410 so as to add a second optical signal to the first optical fibre 401.

As will be described in more detail below, the operation of the optical configuration unit 430 at one node of the network may be coordinated with the operation of an optical configuration unit of another node so as to enable communication between the two nodes. In some examples, optical network node 400 may further comprise a second OADM coupled to a second optical fibre. In some examples, the first optical fibre 401 and the second optical fibre may be unidirectional in that optical signals may only travel in one direction along each fibre. In such examples, the direction of travel along the first optical fibre 401 and the second optical fibre may be opposite.

The optical configuration unit 430 may be coupled between the transceiver 420 and the second OADM. The optical configuration unit 430 may be operable to selectively couple the receiver 422 to the second OADM so as to receive an optical signal dropped from the second optical fibre or to selectively couple the transmitter 424 to the second OADM so as to add an optical signal to the second optical fibre. The operation of the optical configuration unit 430 of the node 400 may thus be coordinated with the operation of the optical configuration unit at another node to enable communication between the two nodes. For example, optical configuration unit 430 may be configured to couple receiver 422 to the first OADM 410, so as to drop an optical signal received from a second optical network node from first optical fibre 401. Optical configuration unit 430 may thus also be configured to couple the transmitter 424 to the second OADM so as to add a second optical signal to the second optical fibre, to transmit the optical signal on the second optical fibre to the second optical network node. At the second optical network node, the respective optical configuration unit may be configured to couple a receiver to a second OADM so as to drop the optical signal from the second optical fibre, transmitted by the first optical network node 400. At the second optical network node, the respective optical configuration unit may further be configured to couple the transmitter to a first OADM, so as to add the optical signal to the first optical fibre 401 for transmission to the first optical network node 400.

In this way, by coordinating the operation of the optical configuration units between two optical network nodes, two optical network nodes may communicate directly with each other.

Furthermore, in some examples, each optical network node of a network may comprise a plurality of optical configuration units according to the present disclosure, and a corresponding plurality of transceivers. In such examples, each optical network node may be configured to communicate directly with each other optical network node of the network by appropriate configuration of the optical configuration units. In such examples, an optical network utilising WDM technology may be formed using a non-hierarchical structure.

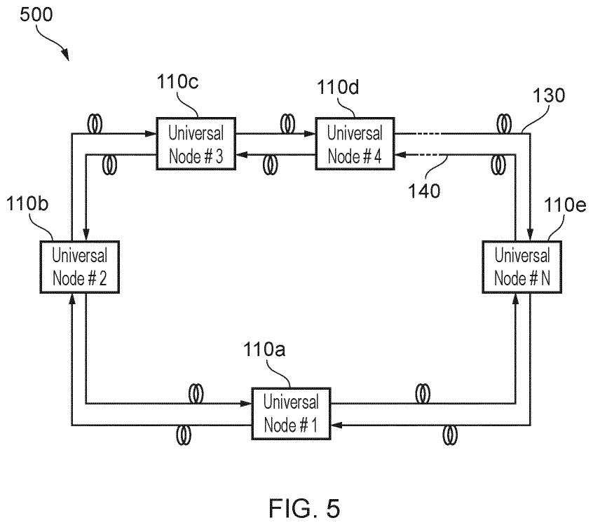

FIG. 5 illustrates an example of an optical network 500 according to the present disclosure. Optical network 500 is configured in a ring network architecture and comprises a plurality of optical network nodes 110a-e. In some examples, each optical network node of an optical network according to the present disclosure may be referred to as a universal optical network node. The optical network 500 further comprises an outer optical fibre 130, which in some examples may be referred to as a first optical fibre, coupled to each of the universal optical network nodes 110a-e. The optical network 500 further comprises an inner optical fibre 140, which in some examples, may be referred to as a second optical fibre, coupled to each of the universal optical network nodes 110a-e.

Each of the plurality of optical network nodes 110a-e are configured to add optical signals to the outer optical fibre 130 such that the optical signals travel along the outer optical fibre 130 in only a first direction, which in the illustrated example of FIG. 5 is the clockwise direction. Similarly, each of the plurality of optical network nodes 110a-e are configured to add optical signals to the inner optical fibre 140 such that optical signals travel along the inner optical fibre 140 in only a second direction, opposite the first direction, which in the illustrated example of FIG. 5 is the anti-clockwise direction.

Each universal optical network node 110a-e may comprise a plurality of optical configuration units corresponding to the plurality of universal optical network nodes 110a-e, a first OADM, a plurality of transceivers corresponding to the plurality of universal optical network node 110a-e and a second OADM, as described above. Therefore, in such examples, each universal optical network node 110a-e may communicate directly with each other optical network node 110a-e by appropriate configuration of the respective optical configuration units. Optical network 500 may therefore adopt a non-hierarchical network structure, without the presence of a hub node. In some examples, each universal optical network node 110a-e may comprise a plurality of optical configuration units which may be less than the number of universal optical network nodes 110a-e and a plurality of transceivers which may be less than the number of optical network nodes 110a-e. In such examples, each universal optical network node 110a-e may communicate directly with each other optical network node 110a-e by appropriate configuration of the respective optical configuration units.

In some examples, each universal optical network node 110a-e may communicate directly with a subset of the other optical network nodes 110a-e by appropriate configuration of the respective optical configuration units. In such examples, each universal optical network node 110a-e may comprise the functionality to communicate directly with each other optical network node 110a-e, but may be configured to communicate directly with only a subset of the other optical network nodes 110a-e.

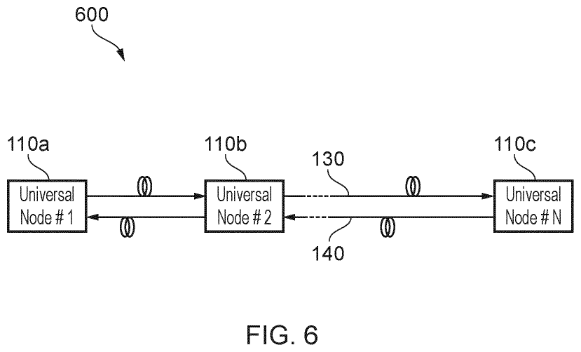

FIG. 6 illustrates another example of an optical network 600 according to the present disclosure. Optical network 600 is configured in a bus network architecture and comprises a plurality of universal optical network nodes 110a-c. Optical network 600 further comprises an upper optical fibre 130, which in some examples may be referred to as a first optical fibre, coupled to each of the universal optical network nodes 110a-c. The optical network 600 further comprises a lower optical fibre 140, which in some examples, may be referred to as a second optical fibre, coupled to each of the universal optical network nodes 110a-c.

Optical network 600 may be configured in a similar manner to optical network 500, where each universal optical network node 110a-c may be configured to add an optical signal to the lower optical fibre 130 such that the optical signals travel along the lower optical fibre 130 in only a first direction. Similarly, each universal optical network node 110a-c may be configured to add an optical signal to the upper optical fibre 140 such that the optical signals travel along the upper optical fibre 140 in only a second direction, opposite the first direction.

Each universal optical network node 110a-c may comprise a plurality of optical configuration units corresponding to the plurality of universal optical network nodes 110a-c, a first OADM, a plurality of transceivers corresponding to the plurality of universal optical network node 110a-c and, a second OADM, as described above. Therefore, in such examples, each universal node 110a-c of network 600 may communicate directly with each other node by appropriate configuration of the respective optical configuration units. Optical network 600 may therefore adopt a non-hierarchical network structure, without the presence of a hub node.

Each node of an optical network according to examples of the present disclosure may thus effectively operate as an add/drop node able to communicate directly with each other add/drop node of the network. Thus, in some examples, none of the add/drop nodes of an optical network according to examples of the present disclosure may not act as a hub node. However, in other examples, at least one node of an optical network may act as a hub node to provide a link to a backhaul network or to the core network. For example, referring again to FIG. 5, first universal node 110a may act as a hub node for the other universal nodes 110b-e to provide a link between the other universal nodes 110b-e and a backhaul network or to the core network. However, in other examples, a plurality of the universal nodes 110a-e may comprise a link to a backhaul network or core network and thus any of the plurality may act as a “hub” node. In other examples, each of the universal nodes 110a-e may comprise a link to a backhaul network or core network.

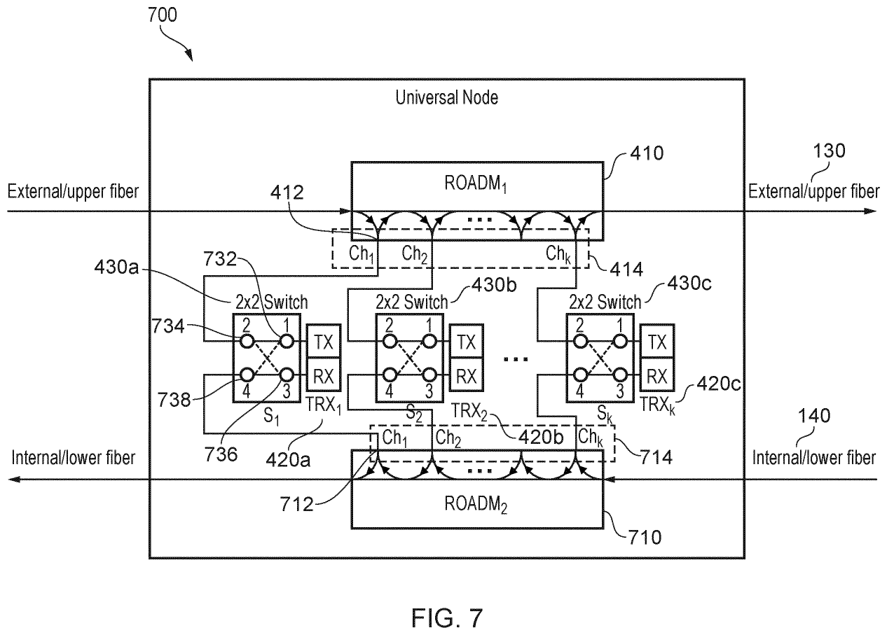

FIG. 7 illustrates another example of an optical network node 700 according to an example of the present disclosure. Optical network node 700 comprises a number of elements in common with optical network 400, which are labelled with corresponding reference numerals. Optical network node 700 may comprise the optical network node 400. Optical network node 700 may therefore comprise at least some of the functionality described above with reference to FIG. 4. In some examples, optical network node 700 may further comprise each of the universal optical network nodes described above with respect to FIGS. 5 and 6.

Optical network node 700 thus comprises a first OADM 410 coupled to first optical fibre 130. In the illustrated example of FIG. 7 first OADM 410 is a reconfigurable OADM (ROADM). First OADM 410 further comprises a first plurality of channel ports 414 comprising a first channel port 412. Each of the first plurality of channel ports 414 is coupled to a first optical fibre 130. As will be described in more detail below, each channel port of the first plurality 414 may be selectively coupled to a receiver or a transmitter of a respective transceiver 420a-c by operation of a respective optical configuration unit 430a-c.

Similarly, optical network node 700 further comprises second OADM 710 coupled to a second optical fibre 140. In the illustrated example of FIG. 7, second OADM 710 is a ROADM. Second OADM 710 comprises a second plurality of channel ports 714 comprising a second channel port 712. Each of the second plurality of channel ports 714 is coupled to a second optical fibre 140. As will be described in more detail below, each channel port of the second plurality 714 may be selectively coupled to a receiver or a transmitter of a respective transceiver 420a-c by operation of a respective optical configuration unit 430a-c.

As described above, optical network node 700 may be operable to add optical signals to the first optical fibre 130 to travel along the first optical fibre 130 in only a first direction. Optical network node 700 may further be operable to add optical signals to the second optical fibre 140 to travel along the second optical fibre 140 in only a second direction, opposite to the first direction. As such, optical signals may only travel in one direction along the first optical fibre 130 in only the first direction and along the second optical fibre 140 in only the second direction.

Optical network node 700 further comprises first transceiver 420a, second transceiver 420b and third transceiver 420c. First, second and third transceivers 420a-c each comprise a respective transmitter Tx and receiver Rx. Optical network node 700 may thus comprise a plurality of transceivers 420a-c. In the illustrated example of FIG. 7, the optical network node 700 comprises three transceivers 420a-c. However, the skilled person will understand that optical network node 700 may comprise any number of suitable transceivers.

Optical network node 700 further comprises a plurality of 2×2 optical switch units 430a-c. In examples according to the present disclosure, an optical configuration unit, as described above, may comprise an optical switch unit, such as the 2×2 optical switch units 430a-c. Each 2×2 optical switch unit 430a-c may thus be coupled between a respective transceiver 420a-c and a respective channel port of the first plurality of channel ports 414. Each 2×2 optical switch unit 430a-c may thus be operable to selectively couple a receiver Rx of a respective transceiver 420a-c to a respective channel port of the first plurality 414 so as to receive an optical signal dropped from the first optical fibre 130, or to selectively couple a transmitter Tx of a respective transceiver 420a-c to the respective channel port of the first plurality 414 so as to add an optical signal to the first optical fibre 130. Similarly, each 2×2 optical switch unit 430a-c may be operable to selectively couple a receiver Rx of a respective transceiver 420a-c to a respective channel port of the second plurality 714 so as to receive an optical signal dropped from the second optical fibre 140, or to selectively couple a transmitter Tx of a respective transceiver 420a-c to the respective channel port of the second plurality 714 so as to add an optical signal to the second optical fibre 140.

Referring to first 2×2 switch unit 430a, the first switch unit 430a comprises a first port 732 connected to the transmitter Tx of the first transceiver 420a, a second port 734 connected to the first channel port 412 of the first OADM 410, a third port 736 connected to the receiver Rx of the first transceiver 420a and a fourth port 738 connected to the second channel port 712 of the second OADM 710.

The first switch unit 430a may be operable in a first configuration and a second configuration. In a first configuration, the first 2×2 switch unit 430a is configured to couple the transmitter Tx of the first transceiver 420a to the first channel port 412 of the first OADM 410 and to couple the receiver Rx of the first transceiver 420a to the second channel port 712 of the second OADM 710. In such a first configuration, the optical network node 700 may thus be configured to add an optical signal to the first optical fibre 130, transmitted by the transmitter Tx of the first transceiver 420a and to drop an optical signal from the second optical fibre 140 to the receiver Rx of the first transceiver 420a. In the first configuration, the first port 732 may thus be coupled to the second port 734 and the third port 736 may thus be coupled to the fourth port 738.

In the second configuration, the first 2×2 switch unit 430a is configured to couple the transmitter Tx of the first transceiver 420a to the second channel port 712 of the second OADM 710 and to couple the receiver Rx of the first transceiver 420a to the first channel port 412 of the first OADM 410. In such a second configuration, the optical network node 700 may thus be configured to add an optical signal to the second optical fibre 140, transmitted by the transmitter Tx of the first transceiver 420a and to drop an optical signal from the first optical fibre 130 to the receiver Rx of the first transceiver 420a. In the second configuration, the first port 732 may thus be coupled to the fourth port 738 and the third port 736 may thus be coupled to the second port 734.

As illustrated in FIG. 7, each of the plurality of 2×2 switch units 430a-c, may each comprise first, second, third and fourth ports, which may adopt a first configuration or a second configuration corresponding to the first and second configurations described above with respect to the first 2×2 switch unit 430a. As such, each of the plurality of 2×2 switch units 430a-c, with a respective one of the transceivers 420a-c, may each be selectively operable to add or drop an optical signal to or from a respective channel port of the first plurality 414 and a respective channel port of the second plurality 714.

As described above, optical network node 700 may comprise each of the universal optical network nodes described above with respect to FIGS. 5 and 6. As such, optical network node 700 may be operable to communicate directly with any other optical network node comprised in the same network as the optical network node 700. For example, referring again to FIG. 5, a duplex communication channel may be established between second universal optical network node 110b and the fourth universal optical network node 110d. In one example, a network management system may decide to use the external optical fibre 130 to form the optical path from the second universal optical network node 110b to the fourth universal optical network node 110d and use the internal optical fibre 140 to form the optical path from the fourth universal optical network node 110d to the second universal optical network node 110b.

In such examples, the optical configuration unit of the second universal optical network node 110b may thus be configured to add an optical signal to the external fibre 130 for transmission to the fourth universal optical network node 110d and to drop an optical signal from the internal optical fibre 140, received from the fourth universal optical network node 110d. Referring briefly to FIG. 7, a first 2×2 switch unit 430a of the second universal optical network node 110b may thus be operated in the first configuration with first port 732 coupled to the second port 734 and the third port 736 coupled to the fourth port 738.

Referring again to FIG. 5, in such examples, the optical configuration unit of the fourth universal optical network node 110d may thus be configured to add an optical signal to the internal fibre 140 for transmission to the second universal optical network node 110b and to drop an optical signal from the external optical fibre 130, received from the second universal optical network node 110b. Referring briefly to FIG. 7, a first 2×2 switch unit 430a of the fourth universal optical network node 110d may thus be operated in the second configuration with first port 732 coupled to the fourth port 738 and the third port 736 coupled to the second port 734.

Referring again to FIG. 5, with the optical configuration units of the second universal optical network node 110b and the fourth universal optical network node 110d configured as described above, an optical signal may be transmitted from the second universal optical network node 110b to the fourth universal optical network node 110d on the external optical fibre 130, and from the fourth universal optical network node 110d to the second universal optical network node 110b on the internal optical fibre 130. Said optical signals may thus travel along a first ring network arc comprising the third universal optical network node 110c and pass through the third universal optical network node 110c on both the external optical fibre 130 and the internal optical fibre 140. In such examples, the first and second OADMs of the third universal optical network node 110c may thus be configured to pass the optical signals transmitted between the second universal optical network node 110b and the fourth universal optical network node 110d. For example, said optical signals may comprise the same first wavelength and the first and second OADMs of the third universal optical network node 110c may thus be configured to pass the first wavelength.

In examples according to the present disclosure, the optical signals added to the external optical fibre 130 and the internal optical fibre 140 may thus be added to the wavelength comb transmitted along both the external optical fibre 130 and the internal optical fibre 140. Similarly, the optical signals dropped from the external optical fibre 130 and the internal optical fibre 140 may thus be dropped from the wavelength comb transmitted along the external optical fibre 130 and the internal optical fibre 140.

In some examples, optical network 500 may be operable to change the configuration of the universal optical network nodes 110a-e to change the direction with which optical signals are transmitted between two universal optical network nodes 110a-e for direct communication. For example, a network management system may detect that a portion of optical fibre between two universal optical network nodes 110a-e has become faulty and can no longer be used for communication. In other examples, one of the universal optical network nodes 110a-e may be able to detect that a portion of the optical fibre between two of the nodes 110a-e has become faulty. In such examples, the universal optical network nodes 110a-e of the network 500 may be reconfigured, for example, upon receipt of a control signal, to change how optical signals are added and dropped from the optical fibres 130, 140.

For example, as described above, a duplex communication may be formed between the second universal optical network node 110b and the fourth universal optical network node 110d, where optical signals pass through the third universal optical network node 110c. In one example, a failure may be detected on the external optical fibre 130 or the external optical fibre 140 between the second universal optical network node 110b and the third universal optical network node 110c. As such, the optical configuration units of the second universal optical network node 110b and the fourth universal optical network node 110d may be reconfigured to maintain communication between the second universal optical network node 110b and the fourth universal optical network node 110d.

In such examples, the optical configuration unit of the second universal optical network node 110b may thus be reconfigured to add an optical signal to the internal fibre 140 for transmission to the fourth universal optical network node 110d and to drop an optical signal from the external optical fibre 130, received from the fourth universal optical network node 110d. In some examples, the second universal optical network node 110b may be reconfigured responsive to receiving a control signal. Referring briefly to FIG. 7, a first 2×2 switch unit 430a of the second universal optical network node 110b may thus switch operation to the second configuration with first port 732 coupled to the fourth port 738 and the third port 736 coupled to the second port 734, responsive to receiving the control signal.

In such examples, the control signal, or a signal derived therefrom, may thus be received by an optical configuration unit. Responsive to receiving the control signal, the optical configuration unit may thus switch the coupling of the transmitter and the receiver between the first and second optical fibres.

Referring again to FIG. 5, in such examples, the optical configuration unit of the fourth universal optical network node 110d may thus be reconfigured to add an optical signal to the external fibre 130 for transmission to the second universal optical network node 110b and to drop an optical signal from the internal optical fibre 140, received from the second universal optical network node 110b. In some examples, the fourth universal optical network node 110d may thus be reconfigured responsive to receiving a control signal. Referring briefly to FIG. 7, a first 2×2 switch unit 430a of the fourth universal optical network node 110d may thus switch operation to the first configuration with first port 732 coupled to the second port 734 and the third port 736 coupled to the fourth port 738, responsive to receiving the control signal.

Referring again to FIG. 5, with the optical configuration units of the second universal optical network node 110b and the fourth universal optical network node 110d configured as described above, an optical signal may be transmitted from the second universal optical network node 110b to the fourth universal optical network node 110d on the internal optical fibre 140, and from the fourth universal optical network node 110d to the second universal optical network node 110b on the external optical fibre 130. Said optical signals may thus travel along a second ring network arc comprising the first universal optical network node 110 and the fifth universal optical network node 110e and pass through the first universal optical network node 110 and the fifth universal optical network node 110e on both the external optical fibre 130 and the internal optical fibre 140. In a similar manner to third universal optical network node 110c described above, first universal optical network node 110 and the fifth universal optical network node 110e may thus both be configured to pass optical signals transmitted between the second universal optical network node 110b and the fourth universal optical network node 110d.

The description above has described the operation of an optical network node according to examples of the present disclosure with reference to optical network 500 configured in a ring network architecture. However, the skilled person will understand that the operation of an optical network node according to examples of the present disclosure may also be implemented in other network architectures, such as bus network architecture 600, illustrated in FIG. 6.

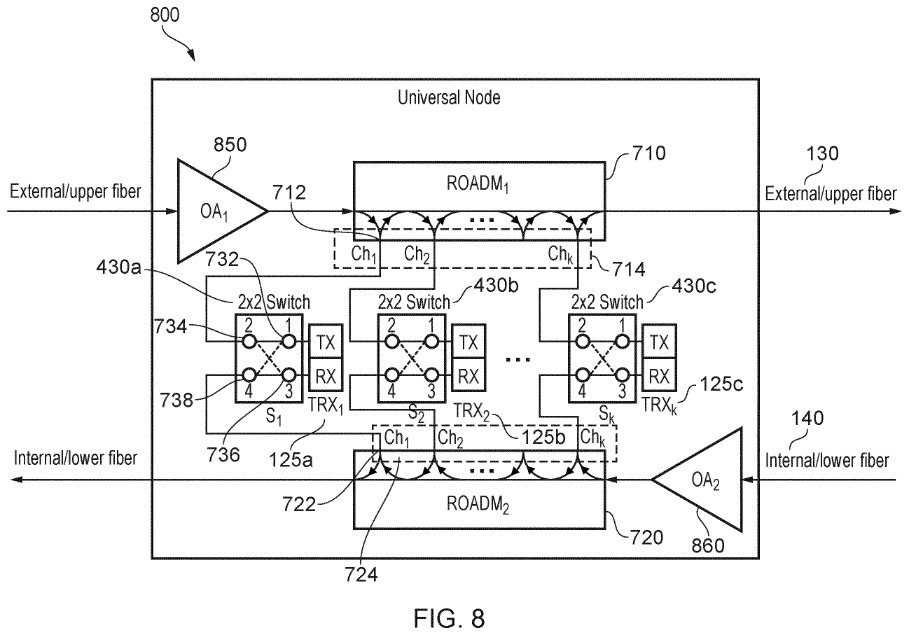

FIG. 8 illustrates another example of an optical network node 800 according to examples of the present disclosure. Optical network node 800 comprises a number of elements in common with optical network node 700, which are labelled with corresponding reference numerals and are not described in detail below for brevity.

Optical network node 800 further comprises a first optical amplifier 850 coupled to the first optical fibre 130 for amplifying optical signals transmitted along the first optical fibre 130. Optical network node 800 further comprises a second optical amplifier 860 coupled to the second optical fibre 140 for amplifying optical signals transmitted along the second optical fibre 140. As the optical signals may travel along the first and second optical fibres 130, 140, in a first direction and a second direction, respectively, regular optical amplifiers can be used to compensate for the losses that may occur at optical network nodes of an optical network, without incurring reflection issues that may occur using bidirectional optical amplifiers in a network where optical signal may travel in both the first and second directions along the first and second optical fibres 130, 140.

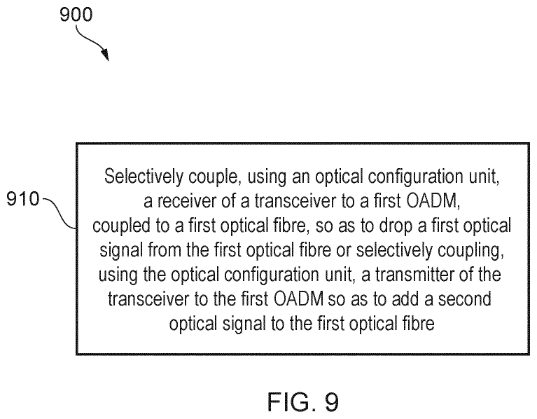

FIG. 9 illustrates a method 900, performed in a first optical network node, according to an example of the present disclosure. The method comprises, in a first step 910, selectively coupling, using an optical configuration unit, a receiver of a transceiver to a first OADM, coupled to a first optical fibre, so as to drop a first optical signal from the first optical fibre or selectively coupling, using the optical configuration unit, a transmitter of the transceiver to the first OADM so as to add a second optical signal to the first optical fibre.

In some examples, the first OADM may comprise a first channel port coupled to the first optical fibre. Therefore, selectively coupling the receiver to the first OADM may comprise selectively coupling the receiver to the first channel port and selectively coupling the transmitter to the first OADM may comprise selectively coupling the transmitter to the first channel port.

In some examples, the method 900 further comprises selectively coupling, using the optical configuration unit, the receiver to a second OADM, coupled to a second optical fibre, so as to receive a third optical signal dropped from the second optical fibre or selectively coupling, using the optical configuration unit, the transmitter to the second OADM so as to add a fourth optical signal to the second optical fibre. In some examples, the second OADM may comprise a second channel port coupled to the second optical fibre. Therefore, selectively coupling the receiver to the second OADM may comprise selectively coupling the receiver to the second channel port and selectively coupling the transmitter to the first OADM may comprise selectively coupling the transmitter to the second channel port.

In some examples, the method 900 may further comprise coupling, using the optical configuration unit, the receiver to the first OADM and coupling, using the optical configuration unit, the transmitter to the second OADM. The method 900 may thus further comprise receiving the first optical signal from a second optical network node and transmitting the fourth optical signal to the second optical network node. In some examples, the method 900 may further comprise receiving a control signal and responsive to receiving the control signal: coupling, using the optical configuration unit, the receiver to the second OADM, coupling, using the optical configuration unit, the transmitter to the first OADM, receiving the third optical signal from the second optical network node, and transmitting the second optical signal to the second optical network node.

In some examples, the optical configuration unit may comprise an optical switch unit. In such examples, selectively coupling the receiver to the first OADM may comprise operating the optical switch unit in a first configuration; and selectively coupling the transmitter to the first OADM may comprise operating the optical switch unit in a second configuration. In some examples, selectively coupling the transmitter to the second OADM may comprise operating the optical switch unit in the first configuration and selectively coupling the receiver to the second OADM may comprise operating the optical switch unit in the second configuration. In some examples, the optical switch unit may comprise: a first port connected to the transmitter; a second port connected to the first OADM; a third port connected to the receiver; and a fourth port connect to the second OADM. In such examples, operating the optical switch unit in the first configuration may comprise coupling the first port to the second port and the third port to the fourth port and operating the optical switch unit in the second configuration may comprise coupling the first port to the fourth port and the second port to the third port.

In some examples, the method 900 may further comprise amplifying, using a first optical amplifier, optical signals transmitted along the first optical fibre. In some examples, the method 900 may further comprise amplifying, using a second optical amplifier, optical signals transmitted along the second optical fibre.

Examples according to the present disclosure thus provide an optical network node where a channel port of an OADM can be configured to selectively drop an optical signal from a wavelength comb travelling along an optical fibre or to selectively add an optical signal to a wavelength comb travelling along the same optical fibre. The appropriate configuration is provided by an optical configuration unit which can control whether the channel port is coupled to a receiver to drop an optical signal from the optical fibre, or to a transmitter to add an optical signal to the optical fibre. In this way, a duplex optical communication channel can be established between any two nodes of an optical network, using WDM technology, through the appropriate configuration of their respective optical configuration units. The duplex optical communication channel can further be established using any wavelength available at both optical network nodes. In this way, an optical network can be formed using optical network nodes according to examples of the present disclosure, where the optical network may adopt a non-hierarchical structure, without the presence of a hub node.

Examples according to the present disclosure further provide an optical network node where the components of said node can be implemented in integrated silicon photonics, which reduces the footprint and cost of the optical network node over conventional solutions.

Examples according to the present disclosure further provide an optical network node in which a duplex communication channel is formed between two nodes over the arc of a ring network, or segments of a bus network, thus making the optical network node suitable for applications in which path symmetry is important, for example, as defined in the Common Public Radio Interface (CPRI) protocol.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-35. (canceled)

36. A first optical network node comprising:
a first optical add-drop multiplexer (OADM) coupled to a first optical fiber;
a transceiver comprising a receiver and a transmitter; and
an optical configuration unit coupled between the transceiver and the first OADM, wherein the optical configuration unit is operable to selectively couple the receiver to the first OADM so as to receive a first optical signal dropped from the first optical fiber or to selectively couple the transmitter to the first OADM so as to add a second optical signal to the first optical fiber.

37. The first optical network node of claim 36, wherein the first OADM comprises a first channel port coupled to the first optical fiber, wherein the optical configuration unit is operable to selectively couple the receiver to the first channel port so as to receive the first optical signal dropped from the first optical fiber, and wherein the optical configuration unit is operable to selectively couple the transmitter to the first channel port so as to add the second optical signal to the first optical fiber.

38. The first optical network node of claim 36, further comprising:
a second OADM coupled to a second optical fiber; and
wherein the optical configuration unit is coupled between the transceiver and the second OADM, wherein the optical configuration unit is operable to selectively couple the receiver to the second OADM so as to receive a third optical signal dropped from the second optical fiber or to selectively couple the transmitter to the second OADM so as to add a fourth optical signal to the second optical fiber.

39. The first optical network node of claim 38, wherein the second OADM comprises a second channel port coupled to the second optical fiber, wherein the optical configuration unit is operable to selectively couple the receiver to the second channel port so as to receive the third optical signal dropped from the second optical fiber, and wherein the optical configuration unit is operable to selectively couple the transmitter to the second channel port so as to add the fourth optical signal to the second optical fiber.

40. The first optical network node of claim 38, wherein the optical configuration unit is configured to couple the receiver to the first OADM and couple the transmitter to the second OADM, so as to receive the first optical signal from a second optical network node and so as to transmit the fourth optical signal to the second optical network node.

41. The first optical network node of claim 40, wherein the optical configuration unit is configured to receive a control signal and, responsive to receiving the control signal, the optical configuration unit is configured to couple the receiver to the second OADM and couple the transmitter to the first OADM, so as to receive the third optical signal from the second optical network node and so as to transmit the second optical signal to the second optical network node.

42. The first optical network node of claim 36, wherein the optical configuration unit comprises an optical switch unit operable in a first configuration to couple the transmitter to the first OADM and operable in a second configuration to couple the first OADM to the receiver.

43. The first optical network node of claim 42, further comprising:
a second OADM coupled to a second optical fiber; and
wherein the optical configuration unit is coupled between the transceiver and the second OADM, wherein the optical configuration unit is operable to selectively couple the receiver to the second OADM so as to receive a third optical signal dropped from the second optical fiber or to selectively couple the transmitter to the second OADM so as to add a fourth optical signal to the second optical fiber, and
wherein the optical switch unit is operable in the first configuration to couple the receiver to the second OADM and operable in the second configuration to couple the second OADM to the transmitter.

44. The first optical network node of claim 43, wherein the optical switch unit comprises:
a first port connected to the transmitter;
a second port connected to the first OADM;
a third port connected to the receiver; and
a fourth port connect to the second OADM;
wherein, in the first configuration, the first port is coupled to the second port and the third port is coupled to the fourth port; and
wherein, in the second configuration, the first port is coupled to the fourth port and the second port is coupled to the third port.

45. The first optical network node of claim 36, further comprising a first optical amplifier coupled to the first optical fiber for amplifying optical signals transmitted along the first optical fiber.

46. The first optical network node of claim 45, further comprising:
a second OADM coupled to a second optical fiber;
a second optical amplifier coupled to the second optical fiber for amplifying optical signals transmitted along the second optical fiber; and
wherein the optical configuration unit is coupled between the transceiver and the second OADM, wherein the optical configuration unit is operable to selectively couple the receiver to the second OADM so as to receive a third optical signal dropped from the second optical fiber or to selectively couple the transmitter to the second OADM so as to add a fourth optical signal to the second optical fiber.

47. An optical network comprising:
a plurality of optical network nodes; and
a first optical fiber coupled to each of the plurality of optical network nodes;
wherein each of the plurality of optical network nodes comprises:
a first optical add-drop multiplexer (OADM) coupled to the first optical fiber;
a transceiver comprising a receiver and a transmitter; and
an optical configuration unit coupled between the transceiver and the first OADM, wherein the optical configuration unit is operable to selectively couple the receiver to the first OADM so as to receive a first optical signal dropped from the first optical fiber or to selectively couple the transmitter to the first OADM so as to add a second optical signal to the first optical fiber.

48. The optical network of claim 47, wherein the first OADM comprises a first channel port coupled to the first optical fiber, wherein the optical configuration unit is operable to selectively couple the receiver to the first channel port so as to receive the first optical signal dropped from the first optical fiber, and wherein the optical configuration unit is operable to selectively couple the transmitter to the first channel port so as to add the second optical signal to the first optical fiber.

49. The optical network of claim 47, wherein each of the plurality of optical network nodes are configured to add optical signals to the first optical fiber such that the optical signals travel along the first optical fiber in only a first direction.

50. The optical network of claim 47, further comprising a second optical fiber coupled to each of the plurality of optical network nodes; wherein each of the plurality of optical network nodes further comprises:
a second OADM coupled to the second optical fiber; and
wherein the optical configuration unit is coupled between the transceiver and the second OADM, wherein the optical configuration unit is operable to selectively couple the receiver to the second OADM so as to receive a third optical signal dropped from the second optical fiber or to selectively couple the transmitter to the second OADM so as to add a fourth optical signal to the second optical fiber.

51. The optical network of claim 50, wherein the second OADM comprises a second channel port coupled to the second optical fiber, wherein the optical configuration unit is operable to selectively couple the receiver to the second channel port so as to receive the third optical signal dropped from the second optical fiber, and wherein the optical configuration unit is operable to selectively couple the transmitter to the second channel port so as to add the fourth optical signal to the second optical fiber.

52. The optical network of claim 50, wherein each of the plurality of optical network nodes are configured to add optical signals to the first optical fiber such that the optical signals travel along the first optical fiber in only a first direction, and wherein each of the plurality of optical network nodes are configured to add optical signals to the second optical fiber such that the optical signals travel along the second optical fiber in only a second direction, opposite the first direction.

53. The optical network of claim 50, wherein the plurality of optical network nodes comprises a first optical network node and a second optical network node; and
wherein the optical configuration unit of the first optical network node is configured to couple the receiver to the first OADM and couple the transmitter to the second OADM, so as to receive the first optical signal from the second optical network node and so as to transmit the fourth optical signal to the second optical network node.

54. The optical network of claim 53, wherein the first optical network node is configured to control the optical configuration unit, responsive to receiving a control signal, to couple the receiver to the second OADM and couple the transmitter to the first OADM, so as to receive the third optical signal from the second optical network node and so as to transmit second optical signal to the second optical network node.

55. The optical network of claim 47, wherein the optical configuration unit of each of the plurality of optical network nodes comprises an optical switch unit operable in a first configuration to couple the receiver to the first OADM and operable in a second configuration to couple the first OADM to the transmitter.

56. The optical network of claim 47, wherein each of the plurality of optical network nodes further comprises a first optical amplifier coupled to the first optical fiber for amplifying optical signals transmitted along the first optical fiber.

57. A method, performed in a first optical network node, the method comprising:
selectively coupling, using an optical configuration unit, a receiver of a transceiver to a first OADM, coupled to a first optical fiber, so as to drop a first optical signal from the first optical fiber or selectively coupling, using the optical configuration unit, a transmitter of the transceiver to the first OADM so as to add a second optical signal to the first optical fiber.

58. The method of claim 57, wherein the first OADM comprises a first channel port coupled to the first optical fiber; wherein selectively coupling the receiver to the first OADM comprises selectively coupling the receiver to the first channel port; and wherein selectively coupling the transmitter to the first OADM comprises selectively coupling the transmitter to the first channel port.

59. The method of claim 57, further comprising:
selectively coupling, using the optical configuration unit, the receiver to a second OADM, coupled to a second optical fiber, so as to receive a third optical signal dropped from the second optical fiber or selectively coupling, using the optical configuration unit, the transmitter to the second OADM so as to add a fourth optical signal to the second optical fiber.

60. The method of claim 59, wherein the second OADM comprises a second channel port coupled to the second optical fiber, wherein selectively coupling the receiver to the second OADM comprises selectively coupling the receiver to the second channel port; and wherein selectively coupling the transmitter to the first OADM comprises selectively coupling the transmitter to the second channel port.

61. The method of claim 59, comprising:
coupling, using the optical configuration unit, the receiver to the first OADM;
coupling, using the optical configuration unit, the transmitter to the second OADM;
receiving the first optical signal from a second optical network node; and
transmitting the fourth optical signal to the second optical network node.
